(19) United States
(12) Patent Application Publication
(10) Pub. No.: US 2007/0247060 A1
(43) Pub. Date: Oct. 25, 2007

(54) Blue-light light-emitting diode

(76) Inventor: Chua Bee Yin Janet, Perak (MY)

Correspondence Address: Kathy Manke;Avago Technologies Limited, 4380 Ziegler Road, Fort Collins, CO, 80525, US

(21) Appl. No.: 11/410,661

(22) Filed: Apr. 25, 2006

(51) Int. Cl. H01J 1/62

(52) U.S. Cl. 313/502

(57) ABSTRACT

An ultraviolet/blue light emitting diode (LED) having enhanced reliability and integrity. The UV and blue-light from the LED passes through a transparent material in which a phosphor material is suspended. The phosphor material redirects the emissibility of harmful UV and blue-light rays into the wavelength range of about 455 to about 475 nanometers and provides stable temperature control. Such minimizes the degradation of the transparent material prolonging the useful life of the LED.

### RELATED APPLICATIONS

This application is related to concurrently filed and commonly assigned U.S. patent application Ser. NO. [Attorney Docket No. 70051674-01] entitled “A SEALED LED HAVING IMPROVED OPTICAL TRANSMISSIBILITY”, the disclosure of which is hereby incorporated herein by reference.

### TECHNICAL FIELD

The present invention relates to light emitting diodes (LED) and the method of manufacturing same. More particularly, the present invention relates to a UV/blue-light LED having phosphor suspended in a translucent material providing improved optical transmissibility and the method of manufacturing same.

### BACKGROUND OF THE INVENTION

Frequently, ultraviolet/blue-light LEDs are used in various applications. Usually the LED is encapsulated within a transparent material, such as epoxy, to provide protection and enhanced operability. However, the ultraviolet (UV) and blue-light generated by such LEDs are known to cause degradation of the surrounding epoxy. If the UV/blue-light LED is used in surface mounted technology (SMT), the LED is typically driven by a higher current. This can generate additional heat which may further aggravate the encapsulating material.

### BRIEF SUMMARY OF THE INVENTION

Embodiments of the present invention include light sources that comprise an LED encapsulated by a transparent material, such as epoxy, with phosphor, suspended within the transparent material, capable of emitting light in the wavelength range of about 455 nanometers to about 475 nanometers. Example phosphors may comprise host materials selected from the group of aluminates, silicates (including orthosilicates), phosphates, borates, titanate, nitrides (including oxynitrates), or any combination thereof. Embodiment phosphors may be activated by one or more activators such as cerium, europium, terbium, samarium, praseodymium, manganese, copper, chlorine, ytterbium, or any combination thereof.

Embodiments of the present invention also include methods of manufacture for LEDs capable of emitting light in the wavelength range of about 455 nanometers to about 475 nanometers. In one example embodiment, a UV LED is first supported by a substrate. A phosphor with a host material such as aluminates, silicates, phosphates, borates, titanate, nitrides, or a combination thereof, is then suspended within a transparent material. The transparent material is then placed on the LED fully encapsulating it against the substrate. The suspended phosphor may be activated by an activator such as cerium, europium, terbium, samarium, praseodymium, manganese, copper, chlorine, ytterbium, or the like, as well as any combination thereof.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying Figures. It is to be expressly understood, however, that each of the Figures is provided for the purpose of illustration and description only and is not intended as a definition of the limits of the present invention.

### BRIEF DESCRIPTION OF THE DRAWINGS

For a more complete understanding of the present invention, reference is now made to the following descriptions taken in conjunction with the accompanying drawing, in which:

FIG. 1 is a cross-sectional view of one embodiment of the present invention.

FIG. 2 is a flow diagram depicting the steps of one embodiment of the present invention.

FIG. 3 is a flow diagram depicting an alternative embodiment of the present invention.

### DETAILED DESCRIPTION OF THE INVENTION

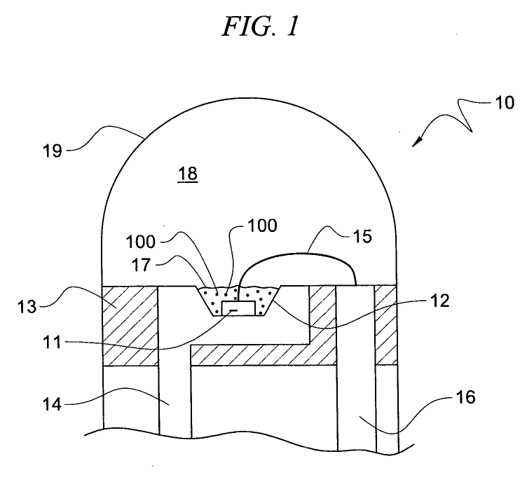

Referring to FIG. 1, light source 10 includes an ultraviolet/blue-light LED 11 supported within cavity 12 of substrate 13. First terminal 14 connects to LED 11, and bond wire 15 extends from LED 11 to second terminal 16. While the embodiment of FIG. 1 depicts one example connection arrangements of LED 15 to terminals 15 and 16, those of ordinary skill in the art will recognize that alternative connections may be used. Transparent material 17, such as an epoxy, fully encapsulates LED 11 within cavity 12 and provides enhanced protection and improved operability. Material 17 is preferably transparent permitting light from LED 11 to pass therethrough into region 18. Region 18 may be filled with a similar epoxy material or other transparent material within optical shell 19. Alternatively, region 18 may be an air gap with associated enhanced operability as discussed in concurrently filed and commonly assigned U.S. patent application Ser. No. ______ [Attorney Docket No. 70051674-01] entitled “A SEALED LED HAVING IMPROVED OPTICAL TRANSMISSIBILITY,” the disclosure of which is hereby incorporated by reference.

UV and blue-light generated by a typical UV/blue LED can cause degradation of transparent material 17 and 18, if present. To avoid this problem, phosphor particles 100 are suspended within transparent material 17. A phosphor is a substance that exhibits the phenomenon of phosphorescence, i.e., sustained glowing without further stimulus. Phosphors are usually made from a suitable host material to which an activator is added. Example host materials used in embodiments of the present invention are aluminates, silicates, phosphates, borates, titanate, nitrides and any combination thereof. For purposes of this disclosure silicates include orthosilicates and nitrides include oxynitrates.

Embodiments of the present invention may also include a suitable activator added to the host material to stimulate the host material. Example activators used by embodiments of the present invention are cerium, europium, terbium, samarium, praseodymium, manganese, copper, chlorine, ytterbium, or any combination thereof.

For the example depicted in FIG. 1, the phosphor material 100 is selected to transition the UV and blue-light emanating from the LED into emissions in the wavelength range of approximately 455 nanometers to approximately 475 nanometers. This helps minimize the degradation of the transparent material and can prolong the useful life of the LED. In many embodiments of the present invention the use of the phosphor material serves to help LED 11 remain temperature stable, further helping prolong the useful life of the LED and permitting the use of LEDs requiring more current.

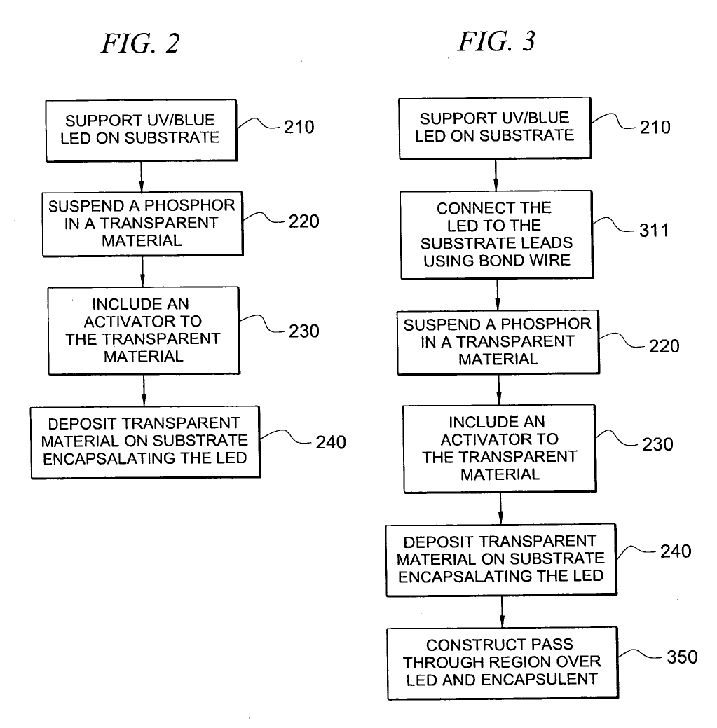

FIG. 2 illustrates the steps of an example embodiment of the present invention. In step 210, a UV/blue LED is supported by a substrate. In step 220, a phosphor is then suspended within a transparent material. Example phosphors used in embodiments of the present invention comprise a host material selected from the group consisting from the group of aluminates, silicates, phosphates, borates, titanate and nitrides. The phosphors may comprise one, or more than one, host material. In step 230, an activator is included to aide in initiating the phosphor activity. Example embodiments use activators such as cerium, europium, terbium, samarium, praseodymium, manganese, copper, chlorine, ytterbium or any combination thereof, as the phosphors used in embodiments of the present invention may comprise one, or more than one, activator. In step 240, the transparent material holding the phosphor, typically epoxy, is deposited on the LED fully encapsulating the light emitting diode against the substrate.

FIG. 3 depicts steps of alternative embodiments of the present invention. After step 210, the LED is connected to the leads of the substrate using a bond wire, in step 311. After steps 220 and 230, a pass-through region is arranged on top of the LED and encapsulant in step 340. In some embodiments, this region is constructed from transparent epoxy forming a dome or other light directing structure. In alternative embodiments, the pass-through region is constructed from an air gap as discussed in the above referenced concurrently filed application.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A light source comprising a light-emitting diode encapsulated by a transparent material having phosphor suspended therein, said phosphor being capable of emitting light in wavelength range of about 455 nanometers to about 475 nanometers.

2. The light source of claim 1 wherein said phosphor comprises a host material selected from the group consisting of aluminates, silicates, phosphates, borates, titanate, nitrides, and any combination thereof.

3. The light source of claim 2 wherein said silicates include orthosilicates.

4. The light source of claim 2 wherein said nitrides include oxynitrates.

5. The light source of claim 1 wherein said phosphor further comprises an activator selected from the group consisting of cerium, europium, terbium, samarium, praseodymium, manganese, copper, chlorine, ytterbium, and any combination thereof.

6. A light source comprising a light-emitting diode encapsulated by a transparent material having phosphor suspended therein, said phosphor comprising a host material selected from the group consisting of aluminate, silicates, phosphates, borates, titanate, nitrides, and any combination thereof.

7. The light source of claim 6 wherein said silicates include orthosilicates.

8. The light source of claim 6 wherein said nitrides include oxynitrates.

9. The light source of claim 6 wherein said phosphor further comprises an activator selected from the group consisting of cerium, europium, terbium, samarium, praseodymium, manganese, copper, chlorine, ytterbium, and any combination thereof.

10. A system for providing light, said system comprising:
a base;
a light-emitting diode supported by said base; and
a transparent encapsulating material covering said diode, wherein said transparent material has phosphor suspended therein capable of emitting light in the wavelength range of about 455 nanometers to about 475 nanometers.

11. The system of claim 10 wherein said phosphor comprises a host material selected from the group consisting aluminates, silicates, phosphates, borates, titanate, nitrides, and any combination thereof.

12. The system of claim 10 wherein said phosphor further comprises an activator selected from the group consisting of cerium, europium, terbium, samarium, praseodymium, manganese, copper, chlorine, ytterbium, and any combination thereof.

13. The system of claim 10 wherein said base is a substrate and further comprising:
leads embedded in said base and connected to said diode.

14. The system of claim 13 wherein at least one said lead is connected to said diode by bond wire.

15. The system of claim 10 further comprising:
a pass-through structure forming an air gap covering said diode.

16. A method of manufacturing a light-emitting diode capable of emitting blue-light in the range of about 455 nanometers to about 475 nanometers, comprising the steps of:
providing an ultraviolet light light-emitting diode supported by a substrate;
suspending a phosphor comprising a host material selected from the group consisting of aluminate, silicates, phosphates, borates, titanate, nitrides, and any combination thereof within a transparent material; and
encapsulating said light-emitting diode with said transparent material.

17. The method according to claim 16 further comprising the step of activating the phosphor with an activator selected from the group consisting of cerium, europium, terbium, samarium, praseodymium, manganese, copper, chlorine, ytterbium, and any combination thereof.

18. The method according to claim 16 wherein said silicates include orthosilicates.

19. The method according to claim 16 wherein said nitrides include oxynitrates.

20. The method of manufacturing a surface mounted source of blue light, said method comprising:
providing an ultraviolet light emitting diode supported by a substrate;
suspending a phosphor comprising a host material selected from the group consisting of aluminates, silicates, phosphates, borates, titanate, nitrides, and any combination thereof within a transparent material;
activating the phosphor with an activator selected from the group consisting of cerium, europium, terbium, samarium, praseodymium, manganese, copper, chlorine, ytterbium, and any combination thereof; and
encapsulating said light-emitting diode with said transparent material.

21. The method of claim 20 further comprising:
connecting said diode to at least one lead in said substrate using bond wire.

22. The method of claim 20 further comprising:
forming a dome structure above said diode from a transparent encapsulating material.

23. The method of claim 20 wherein said transparent material is epoxy.
